(19) United States
(12) Patent Application Publication
(10) Pub. No.: US 2020/0346750 A1
(43) Pub. Date: Nov. 5, 2020

(54) METHOD FOR GENERATING FLIGHT PATH, CONTROL DEVICE, AND UNMANNED AERIAL VEHICLE

(71) Applicant: SZ DJI TECHNOLOGY CO., LTD., Shenzhen (CN)

(72) Inventors: Xiao HU, Shenzhen (CN); Ang LIU, Shenzhen (CN); Litian ZHANG, Shenzhen (CN); Shuyuan MAO, Shenzhen (CN); Chengwei ZHU, Shenzhen (CN)

(21) Appl. No.: 16/407,664

(22) Filed: May 9, 2019

Related U.S. Application Data
(63) Continuation of application No. PCT/CN2016/105773, filed on Nov. 14, 2016.

(51) Int. Cl. B64C 39/02; G06K 9/00; G05D 1/00

(52) U.S. Cl. CPC B64C 39/024; B64C 2201/146; G05D 1/0033; G06K 9/0063

(57) ABSTRACT

A method of generating a flight path includes obtaining an image and a curve, the curve being plotted on the image. The method also includes generating the flight path based on the image and the curve, the flight path being configured for controlling an unmanned aerial vehicle (UAV) to fly along the flight path.

### CROSS-REFERENCE TO RELATED APPLICATION

This application is a continuation application of International Application No. PCT/CN2016/105773, filed on Nov. 14, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of unmanned aerial vehicle (UAV) and, more particularly, to a method of generating a flight path, a control device, and an unmanned aerial vehicle.

### BACKGROUND

Conventional unmanned aerial vehicles can be operated under different modes. The modes include, but are not limited to, a target tracking mode (e.g., point tracking flight mode), an intelligent follow mode, etc.

In a target tracking mode, a user may select a target, such as a point (e.g., a target object) or an area displayed on the display device (e.g., screen) of a remote control as a flight tracking target. The UAV may generate a shortest flight path toward the flight tracking target, and may fly toward the flight tracking target along the shortest flight path. In an intelligent follow mode, a user can select a moving object (e.g., a human being, an animal, etc.) displayed on the display device (e.g., screen) of the remote control as a flight tracking target. The remote control may control the flight of the UAV to follow the moving object.

In certain circumstances, a user may wish the UAV to fly along a specific flight path, such as to pass specific points, or to fly a round trip, etc. In addition, when the user sends out the flight task, the user may not have a precise target. Instead, the user may wish to fly the UAV for a distance before the user sends the location information of the ultimate flight tracking target. Conventional flight modes of a UAV cannot satisfy such demands, rendering the flight modes of the UAV lacking the flexibility for customized or personalized flight mode design.

### SUMMARY

In accordance with the present disclosure, there is provided a method of generating a flight path. The method includes obtaining an image and a curve, the curve being plotted on the image. The method also includes generating the flight path based on the image and the curve, the flight path being configured for controlling an unmanned aerial vehicle (UAV) to fly along the flight path.

Also in accordance with the present disclosure, there is provided a control device. The control device includes one or more processors, operating individually or in collaboration, and being configured to obtain an image and a curve, the curve being plotted on the image. The one or more processors are also configured to generate the flight path based on the image and the curve, the flight path being configured for controlling an unmanned aerial vehicle (UAV) to fly along the flight path.

Further in accordance with the present disclosure, there is provided an unmanned aerial vehicle (UAV). The UAV includes a body and a propulsion system mounted to the body and configured to provide a propulsion force for flight. The UAV also includes a flight control device communicatively coupled with the propulsion system, the flight control device configured to control the flight of the UAV. The flight control device includes a control device. The control device includes one or more processors, operating individually or in collaboration. The one or more processors are configured to obtain an image and a curve, the curve being plotted on the image. The one or more processors are also configured to generate the flight path based on the image and the curve, the flight path being configured for controlling the UAV to fly along the flight path.

In various embodiments of the disclosed flight path generating method, control device, and UAV, a specific curve is plotted or drawn on a specific image, the specific curve being used to generate the flight path for controlling the UAV. The specific curve may be plotted or drawn on a still image based on an input received from a user, or may be a curve plotted or drawn onto one or more image frames of a dynamic video. Correspondingly, the specific image may be a still image, or one or more image frames of a dynamic video. The specific curve drawn on the specific image by the user may be used to generate the flight path for controlling the flight of the UAV. In other words, the UAV may fly according to the specific curve customized or personalized by the user. This enables customization of the flight mode of a UAV. Comparing to the target tracking mode and the intelligent follow mode implementing conventional technologies, the technologies of the present disclosure can improve the flexibility of the flight mode of the UAV.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a method for generating a flight path according to an example embodiment.

FIG. 1A schematically illustrates a coordinate system according to an example embodiment.

FIG. 1B schematically illustrates a specific curve drawn on a plane image by a user according to an example embodiment.

FIG. 2 is a flow chart illustrating a method for generating a flight path according to another example embodiment.

FIG. 2A schematically illustrates a projection ray according to an example embodiment.

FIG. 3 is a flow chart illustrating a method for generating a flight path according to another example embodiment.

FIG. 3A is a schematic diagram showing three-dimensional path points according to an example embodiment.

FIG. 3B is a schematic diagram showing three-dimensional path points according to an example embodiment.

FIG. 3C is a schematic diagram showing three-dimensional path points according to another example embodiment.

FIG. 3D is a schematic diagram showing three-dimensional path points according to another example embodiment.

FIG. 4 is a schematic diagram of a control device according to an example embodiment.

FIG. 5 is a schematic diagram of a control device according to another example embodiment.

FIG. 6 is a schematic diagram of a control device according to another example embodiment.

FIG. 7 is a schematic diagram showing the structure of a UAV according to another example embodiment.

### LIST OF ELEMENTS

Image plane 10
Upper left corner of image plane 02
Projection point of optical center 0 on image plane 01
Projection point of optical center 0 on ground 03
Optical center of imaging device 0
Specific image 20
Starting point of specific curve 21
Ending point of specific curve 22
Control device 40
One or more processors 41
Sensor 42
Display screen 43
Transmitter 44
Receiver 45
Receiver 50
Transmitter 51
Control device 60
Acquisition circuit 61
Determination device 62
Pre-processing circuit 621
Determination circuit 622
Display circuit 63
Receiving circuit 64
Computing circuit 65
Detecting circuit 66
Starting circuit 67
Control circuit 68
Transmitting circuit 6
UAV 100
Motor 107
Propeller 106
Electrical speed control (ESC) 117
Flight control device 118
Sensor system 108
Communication system 110
Supporting apparatus 102
Imaging device 104
Ground station 112
Antenna 114
Electromagnetic wave 116

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The connection may be wired or wireless. When a first component is referred to as “disposed,” “located,” or “provided” on a second component, the first component may be directly disposed, located, or provided on the second component or may be indirectly disposed, located, or provided on the second component via an intermediate component. The terms “perpendicular,” “horizontal,” “left,” “right,” and similar expressions used herein are merely intended for description.

The term “communicatively coupled” indicates that related items are coupled through a communication chancel, such as a wired or wireless communication channel.

The term “curve” used herein encompasses a curve line, as well as a straight line. The terms “specific image” and “specific curve” are used to refer to certain image and certain curve. These terms do not necessarily mean that the image or the curve is predetermined, pre-stored, pre-set, or pre-generated. The term “specific” is used herein to modify the term “image” or “curve” only for the purpose of distinguishing the “image” or the “curve” from other images or other curves. Thus, the term “specific” serves only as part of the name of “specific image” or “specific curve.” In the present disclosure, the specific image is an image onto which the specific curve is drawn. The specific image may be any image from still images or image frames of dynamic videos that is select, e.g., based on input from a user, to draw, plot, place, or superimpose the specific curve.

The terms “plot” and “draw” as used in plotting or drawing a curve (or a specific curve) on an image (or a specific image) refer to situations where a processor generates a curve (or a specific curve) based on an input received from a user, and superimposes (by displaying) the curve (or specific curve) on an image (or a specific image) either after the user finishes drawing the curve (or specific curve), or while the user draws the curve (or specific curve) on the image (or specific image). That is, the specific curve may be plotted or drawn in real time as the user operates (e.g., swipes using a finger or stylus pen or dragging a cursor using a mouse) on the specific image displayed on a screen, or after the user completes drawing the curve. The phrases drawing or plotting the curve on the image also encompass the situations where the specific curve is a computer-generated curve (e.g., based on user input), and the curve is placed or superimposed on a specific image. For example, the specific curve may be generated by the processor based on an input received from the user, and the user may select the specific curve already generated, and place it or superimpose it on the specific image.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

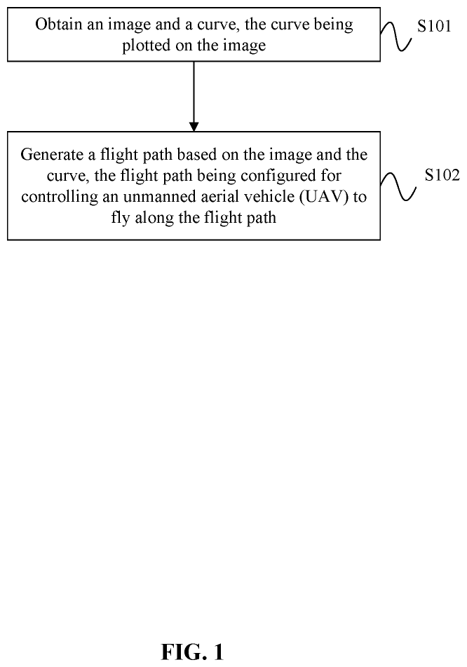

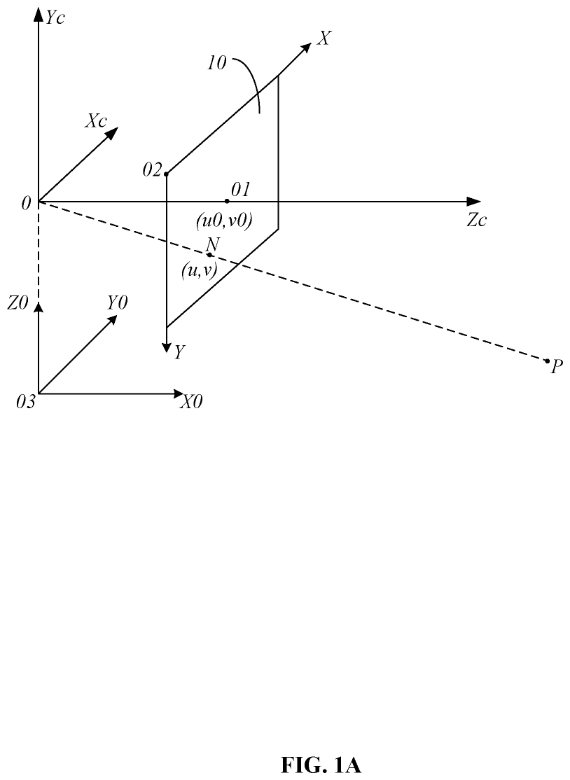

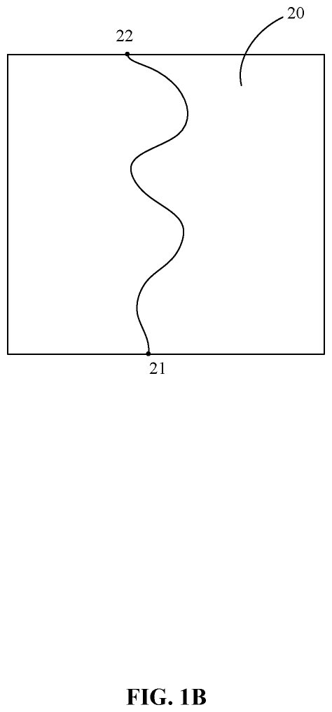

Embodiments of present disclosure provide a method of generating a flight path. FIG. 1 is a flow chart illustrating an example method of generating a flight path. FIG. 1A schematically illustrates an example coordinate system. FIG. 1B schematically illustrate an example specific curve drawn on an example plane image by a user. The methods may be implemented in a ground station, which may be a flight control terminal of the UAV. In some embodiments, the methods may be implemented by a flight control device. In some embodiments, the flight control terminal of the UAV may include, but not be limited to, wearable devices that can be worn on a user's head, such as wearable eye glasses including virtual reality glasses, virtual reality helmets, etc. The flight control terminal may also include cell phones, remote controls (e.g., remote controls with a display screen), smart wrist bands, tablets, etc. UAVs may operate in different modes, such as, for example, target tracking mode, intelligent follow mode, camera focusing mode, etc.

In a target tracking mode, a user may touch a point on a display device (e.g., display screen) of the UAV flight control terminal, or may select an area on the display device as a flight tracking target. The UAV may fly toward the selected flight tracking target.

In an intelligent follow mode, the user can select a moving object (e.g., a person or an animal, etc.) on the display device (e.g., display screen) of the UAV flight control terminal. The UAV flight control terminal may control the UAV to fly following the moving object.

In a camera focusing mode, the user may select a point on a display device (e.g., display screen) of the UAV flight control terminal, or may select an area on the display device as a flight tracking target. The UAV flight control terminal may control the imaging device (e.g., a camera) of the UAV to focus on the selected flight tracking target.

The imaging device mounted on or carried by the UAV may be used for aerial photography. The images acquired by the imaging device may be associated with an image coordinate system. The imaging device may be associated with a camera coordinate system. The UAV may be associated with a ground coordinate system relative to the ground. FIG. 1A schematically illustrate a relationship between the image coordinate system, the camera coordinate system, and the ground coordinate system. As shown in FIG. 1A, reference number 10 denotes an image plane for the images acquired by the imaging device. If the point represented by the reference number 02 is an upper left corner of the image plane, then the point 02 can be an origin of a coordinate system, and a direction pointing to the right in the image plane can be an X-axis, and a direction pointing downward can be a Y-axis. Thus, a two-dimensional coordinate system, i.e., an image coordinate system, can be established by the point 02, the X-axis, and the Y-axis,.

If point 0 is the optical center of the imaging device, axis Xc is parallel with the X-axis, axis Yc is parallel with the Y-axis, the optical axis of the imaging device is axis Zc, then a three-dimensional coordinate system, i.e., a camera coordinate system, can be established using point 0 as the origin, the Xc-axis, the Yc-axis, and the Zc-axis. Further, if the projection point of the optical center 0 on the image plane 10 is point 01, then the coordinates of point 01 in the image coordinate system are (u0, v0), and the distance from the optical center 0 to the point 01 is the focal length f of the imaging device.

If the projection point of the optical center 0 on the ground is point 03, and the UAV is a reference object, a direction pointing to the right of the UAV is the X0-axis, a direction pointing to the front of the UAV is the Y0-axis, a direction perpendicular to the ground is the Z0-axis, then a three-dimensional coordinate system, i.e., the ground coordinate system, can be established based on the point 03, the X0-axis, the Y0-axis, and the Z0-axis. As shown in FIG. 1A, if pixel point N represents any pixel or pixel point in the image plane, then the coordinates of pixel point N in the image coordinate system may be represented by (u, v). A ray can be formed starting from the optical center 0 of the imaging device and running through any pixel point of on the image plane, such as pixel point N. The ray may cross the ground at a point P. Point P may be the back-projection point on the ground corresponding to, or for, each pixel point N on the image plane.

As shown in FIG. 1, a method of generating a flight path can include the following steps:

In step S101, a processor (such as any processor disclosed in an imaging device, the flight control terminal, or the control device associated with the UAV) may obtain an image and a curve, the curve being at least partially plotted on the image. In some embodiments, for convenience, the image on which the curve is at least partially plotted or will be at least partially plotted may be referred to as a specific image, and the curve may be referred to as a specific curve.

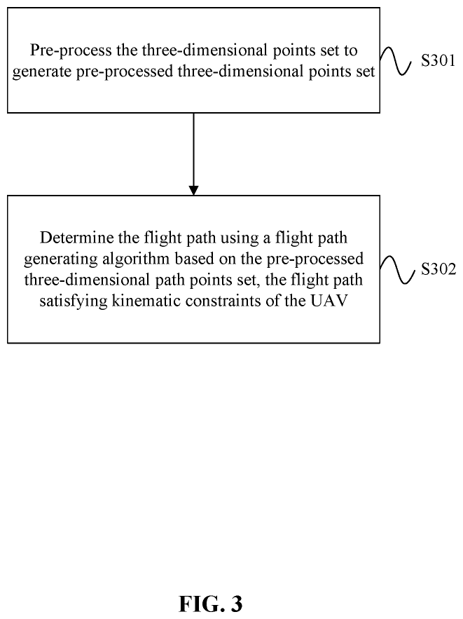

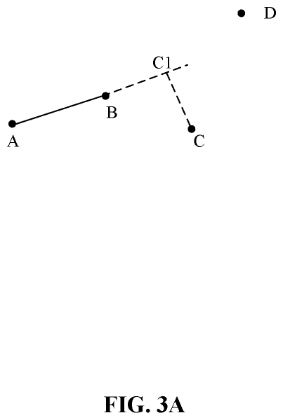

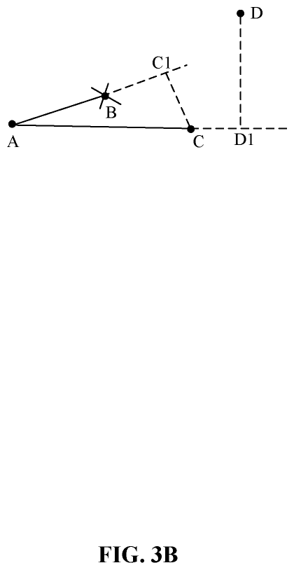

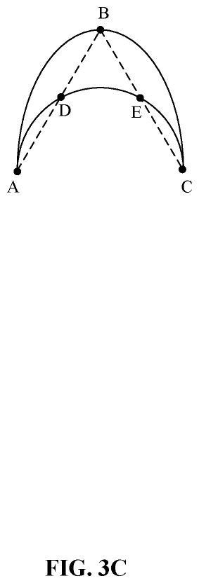

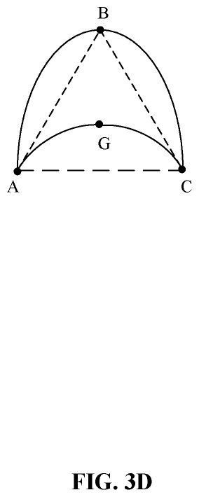

The method shown in FIG. 3 may be implemented by or in the flight control device, or the ground station, i.e., the UAV flight control terminal. In some embodiments, the UAV flight control terminal may include a wearable device, such as wearable virtual reality glasses, a virtual reality helmet, a cell phone, a remote control (such as a remote control having a display screen), a smart wrist band, a tablet, etc. The UAV can be operated in different modes, which may include, but not be limited to, target tracking mode, intelligent follow mode, camera focusing mode, etc. The UAV may be mounted with or carry an imaging device. The imaging device may include at least one of a camera or a camcorder. The imaging device may be used for aerial photography to acquire at least one of still images or dynamic videos.

In some embodiments, the method may be implemented by the ground station. The ground station may use one or more methods disclosed herein to obtain the specific image and the specific curve. For example, the ground station may use one of at least three methods to obtain the specific image and the specific curve, according to the present disclosure.

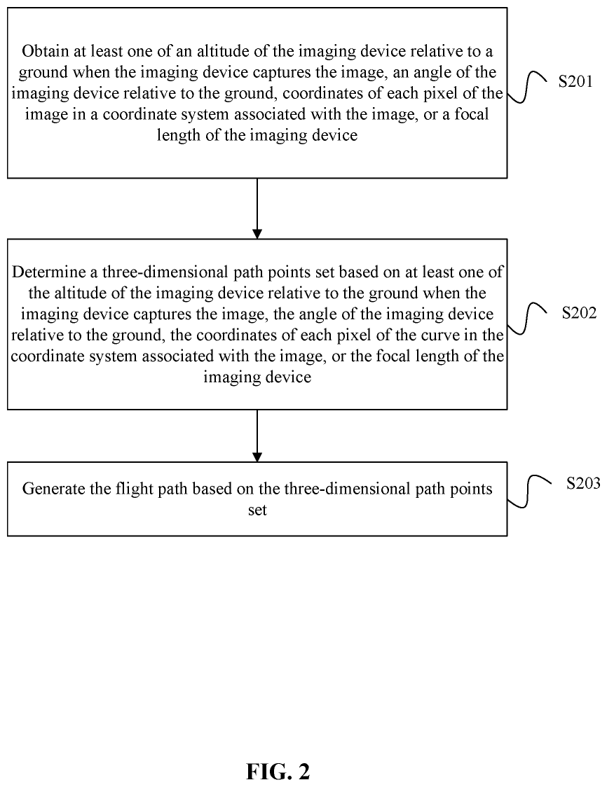

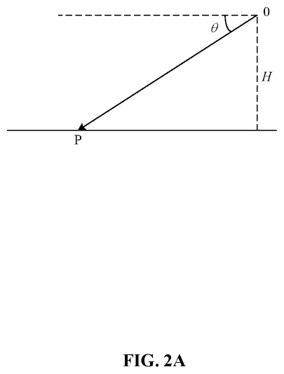

In a first method, the UAV control device may send the real-time images acquired by the imaging device, such as still images and/or dynamic videos, to the ground station. The ground station may be equipped with one or more display screens. After receiving the still images and/or the dynamic videos, the display screen may display the still images and/or dynamic videos to a user or operator. In some embodiments, the display screen may be a touch screen, which may sense an input or operation of the user on the touch screen, such as a sliding, clicking, touching, selecting operation. The user may draw or plot a curve on a still image or a video displayed on the touch screen by providing one of the operations on the touch screen. As shown in FIG. 2, reference number 20 denotes an image frame of the still images or video(s) captured or acquired by the imaging device mounted on the UAV. The image frame of the still images or videos may be a two-dimensional plane image, or a three-dimensional image. The following discussion uses a two-dimensional plane image as a non-limiting example. The details of the plane image are not shown in FIG. 2. A user may draw a curve on the plane image displayed on the touch screen. For example, a processor may generate a specific curve connecting points 21 and 22 based on the user input or operation received on the touch screen. In some embodiments, the starting point 21 may represent the present location of the user, or any point in the plane image that may represent certain location. The ending point 22 may be any point in the image plane, or a point representing certain location. The specific curve drawn by the user between the starting point 21 and the ending point 22 may run through predetermined points on the image plane, or may not run through certain points on the image plane. The specific curve may represent a flight path that the user expects the UAV to follow when the UAV flies in the air.

When the user draws the specific curve on a dynamic video, because the video includes multiple image frames, the specific curve drawn by the user may be distributed on the multiple image frames of the video. Thus, the specific image onto which the specific curve is drawn includes multiple image frames of the video that include the specific curve, or one or more of the multiple image frames that include the specific curve. For example, in some embodiments, the ground station may project the specific curve distributed in multiple image frames onto one of the multiple image frames, such as the first image frame. Then, the first image frame is the specific image on which the specific curve is drawn. In the subsequent processes, three-dimensional path points in the ground coordinate system may be calculated for each pixel point on the specific curve based on at least one of an altitude of the imaging device relative to the ground when the first image frame is captured, an angle of the imaging device relative to the ground, or coordinates of each pixel point on the specific curve in the image coordinate system with which the first image frame is associated (e.g., in which the first image frame is located). If the user draws the specific curve on a still image or one image frame of the dynamic video, then the specific image on which the specific curve is drawn is the still image or the one image frame of the dynamic video.

In a second method, based on the first method, after the ground station receives the specific image and the specific curve, the ground station may transmit the specific image and the specific curve to a cloud platform. In some embodiments, the cloud platform may be a server, a server farm, a distributed server, a virtual machine, a virtual machine farm, etc. Other ground station in communication with the cloud platform may download or retrieve the specific image and the specific curve at any time from anywhere. For example, ground station A and ground station B may be configured to control two different UAVs. Ground station A may be configured to control UAV A, and ground station B may be configured to control UAV B. Assuming ground station B has obtained the specific image and the specific curve using the first method discussed above, and ground station A and ground station B can have a real time communication, then ground station B may transmit the specific image and the specific curve to a cloud platform. Even if user A and user B were not connected as friends using the same instant messaging software, for example, as long as ground station A is connected to the cloud platform, user A may download the specific image and the specific curve from the cloud platform to ground station A. User A may control UAV A, in a manner similar to the one used by user B to control UAV B.

In a third method, ground station A and ground station B may be configured to control two different UAVs. For example, ground station A may control UAV A, and ground station B may control UAV B. Assuming that ground station B obtains the specific image and the specific curve using the first method, and ground station A and ground station B are in a real time communication, then ground station B can share the specific image and the specific curve with ground station A, such that ground station A may control the flight path of UAV A based on the specific image and the specific curve. For example, in some embodiments, ground station A and ground station B may both have tablets installed with instant messaging software or applications. User A operates ground station A, and user B operates ground station B. User A and user B communicate with one another through the same instant messaging software installed in ground station A and ground station B. User A and user B may be connected as friends through the instant messaging software. When user B obtains the specific image and the specific curve through ground station B, ground station B may control the flight path of the UAV B based on the specific image and the specific curve. The control of the flight path of the UAV B may be smooth and power-saving. User B may share the specific image and the specific curve with user A through the instant messaging software installed in ground station B, such that user A may control UAV A in a manner similar to that used by user B to control UAV B. Ground station B may share the specific image and the specific curve with not only ground station A, but also other ground stations, such that the other ground stations may control their corresponding UAVs based on the same flight path as used in controlling UAV B. For example, in some embodiments, at some celebration events, the disclosed method may be used to control multiple UAVs to fly, sequentially in time, based on the same flight path. In addition, after ground station B shares the specific image and the specific curve with ground station A, users of ground station A may change the altitude of the UAVs through ground station A, thereby controlling the UAVs to fly at different altitudes (e.g., heights from the ground) following the same flight path. When multiple ground stations share the specific image and the specific curve shared by ground station B, these multiple ground stations may control their corresponding UAVs to fly at different altitudes (e.g., heights) following the same flight path, creating an astonishing visual effect.

When the disclosed method is implemented by a flight control device, the flight control device may obtain the specific image and the specific curve from a ground station through a wireless communication. The method for the ground station to obtain the specific image and the specific curve may be any one or a combination of the three methods discussed above. In some embodiments, the ground station may transmit the specific image and the specific curve to a communication system of the UAV, and the communication system may transmit the specific image and the specific curve to the flight control device.

In some embodiments, when the ground station or the flight control device obtains the specific image, the ground station or the flight control device obtains at least one of an altitude (or height) of the imaging device relative to the ground when the imaging device carried by the UAV captures the specific image, an angle of the imaging device relative to the ground, coordinates of the imaging device in the ground coordinate system, or a focal length of the imaging device. The angle of the imaging device relative to the ground may include at least one of a roll angle, a pitch angle, or a yaw angle of the imaging device. For example, when the flight control device transmits the real time images, such as still images or dynamic videos to the ground station, the flight control device may obtain at least one of the altitude of the UAV when the imaging captures the real time images, the angle of the imaging device relative to the ground, coordinates of the imaging device in the ground coordinate system, or the focal length of the imaging device. The flight control device may store, in a storage device of the UAV, or transmit to the ground station, at least one of the altitude of the UAV when the imaging captures the real time images, the angle of the imaging device relative to the ground, coordinates of the imaging device in the ground coordinate system, or the focal length of the imaging device.

In step S102, a processor generates the flight path based on the specific image and the specific curve, the flight path being configured for controlling the UAV to fly along the flight path. In some embodiments, the processor may control the UAV to fly based on the flight path.

In some embodiments, the flight path may be generated based on the specific image and the specific curve obtained by the flight control device, or may be generated based on the specific image and the specific curve by the ground station. The flight control device and/or the ground station may generate the flight path using the specific curve as a basis. As a plane image includes multiple pixel points, each pixel point has its coordinates in an image coordinate system. The value of each pixel point represents the gray level or brightness of the corresponding pixel. For example, as shown in FIG. 1B, for a specific image 20, the specific curve starting from point 21 and ending at point 22 includes multiple pixel points. If the specific image shown in FIG. 1B is used as the image plane 10 of FIG. 1A, then for any point on the specific curve 21-22, a ray can be formed between the optical center 0 of the lens of the imaging device and the any point on the specific curve. The ray may cross the ground at a crossing point, which is the back-projection point on the ground for or corresponding to the pixel point of the specific curve. Thus, each pixel point on the specific curve 21-22 can be back-projected to the ground to obtain the back-projection point for each pixel point. Because the UAV flies at a height above the ground, if the back-projection point for each pixel point on the specific curve 21-22 is translated to the height of the UAV when the imaging device captures the specific image, a three-dimensional coordinate point is obtained for each pixel point in a three-dimensional space, i.e., the ground coordinate system. In the present disclosure, the three-dimensional coordinate point may be regarded as a three-dimensional path point.

As discussed above, a user can draw a specific curve on a dynamic video, or draw the specific curve on a still image or an image frame of the dynamic video. When the user draws the specific curve on a dynamic video, the specific curve will be distributed on one or multiple image frames of the dynamic video. That is, the pixel points of the specific curve may be distributed on the multiple image frames of the dynamic video. In some embodiments, when determining the back-projection points of the pixel points on the ground, the specific image 20 in the image plane 10 shown in FIG. 1A may be the image frame in which the pixel points of the specific curve are distributed. The image frame in which the pixel points of the specific curve are distributed may also be any image frame of the multiple image frames of the dynamic video in which the specific curve is distributed. In some embodiments, the any image frame may be the first image frame, the middle image frame, or the last image frame of the multiple image frames.

The three-dimensional path points corresponding to the pixel points on the specific curve form a three-dimensional path points set. Algorithms for the disclosed methods of generating the flight path (or flight path generating algorithm) may generate the three-dimensional path points set, which can satisfy the kinematic constraints of the UAV. The flight path generating algorithm may be any algorithm that may generate a path based on multiple path points. For example, the flight path generating algorithm may be an algorithm based on minimum snap. The three-dimensional path generated by a path generating algorithm can not only satisfy the kinematic constraints of the UAV, but also satisfy constraints on smoothness.

The three-dimensional path may be used for controlling the flight of the UAV. For example, the UAV may be controlled to fly along the three-dimensional path. In some embodiments, the three-dimensional path may be the flight path that the UAV follows when the UAV is under control.

When the disclosed methods are implemented by a flight control device, the flight control device may generate the flight path based on the specific image and the specific curve, where the flight path is generated from the specific curve. The flight control device may control the UAV to fly along the flight path. When the disclosed methods are implemented by a ground station, the ground station may generate the flight path based on the specific image and the specific curve, where the flight path may be generated or converted from the specific curve. The ground station may transmit the flight path to the flight control device. The flight control device may control the UAV to fly in the air along the flight path.

In some embodiments, the flight control device or the ground station may transmit (e.g., upload) the flight path to a server, such that other flight control devices or other ground stations may retrieve (e.g., download) the flight path from the server, and control other corresponding UAVs based on the flight path. In some embodiments, the method of generating the flight path may be a first ground station. The first ground station may share the flight path with other ground stations including a second ground station. The other ground stations may control the flight of other corresponding UAVs based on the flight path.

According to embodiments of the present disclosure, a specific curve can be drawn on a specific image. The specific curve can be used to generate a flight path for controlling the flight of the UAV. In some embodiments, the specific curve may be a curve drawn on a still image based on an input received from a user. In some embodiments, the specific curve may be a curve drawn on an image frame or multiple image frames of a dynamic video. Correspondingly, the specific image may be a still image, or an image frame or multiple image frames of a dynamic video. The specific curve drawn on the specific image by the user may be used to control the flight path of the UAV. That is, the UAV may fly along a customized specific curve. Accordingly, the present disclosure enables customization of the flight mode of a UAV. Compared to the conventional technology used in the target tracking mode and the intelligent follow mode, the present disclosure improves the flexibility of flight mode design for UAVs.

An embodiment of the present disclosure provides a method of generating a flight path. FIG. 2 is a flow chart illustrating a method of generating a flight path according to an example embodiment of the present disclosure. FIG. 2A is a schematic illustration of a projection ray. As shown in FIG. 2, based on the method shown in FIG. 1, the method shown in FIG. 2 is a method of generating a flight path based on the specific image and the specific curve. The flight path is generated from the specific curve.

In step S201, a processor may obtain at least one of an altitude of the imaging device relative to a ground when the imaging device captures the image, an angle of the imaging device relative to the ground, coordinates of each pixel point of the curve in a coordinate system associated with the image, or a focal length of the imaging device.

In some embodiments, if the specific image 20 is treated as the image plane 10 shown in FIG. 1A, point 0 is the optical center of the lens included in the imaging device carried by the UAV, the projection point of the optical center 0 on the specific image 20 is point 01, and the coordinates of point 01 in the image coordinate system associated with the specific image 20 (e.g., in which the specific image 20 is located), are (u0, v0), then the distance between the optical center and the point 01 is the focal length of the imaging device. If point N is an arbitrary pixel point on the specific curve 21-22 in the specific image 20, the coordinates of pixel point N in the image plane where the specific image 20 is located are (u, v). A ray can be formed from the optical center 0 of the lens of the imaging device to any pixel point N on the specific curve 21-22. The ray crosses the ground at point P. Point P can be the back-projection point on the ground of pixel point N of the specific curve 21-22.

As shown in FIG. 2A, point 0 is the optical center of the lens of the imaging device carried by the UAV. Point P is the back-projection point for pixel point N of the specific curve 21-22. The straight line between optical center 0 and point P is a projected straight line, which can be denoted as OP. The altitude (e.g., height) of the imaging device relative to the ground is the height of the optical center of the lens of the imaging device relative to the ground, which is the height H shown in FIG. 2A. The angle of the imaging device relative to the ground is denoted as angle θ.

In step S202, a processor determines a three-dimensional path points set based on at least one of the altitude of the imaging device relative to the ground when the imaging device captures the image, the angle of the imaging device relative to the ground, the coordinates of each pixel point of the curve in the coordinate system associated with the image, or the focal length of the imaging device. The three-dimensional path points set includes three-dimensional path points in a ground coordinate system corresponding to pixel points, the pixel points being pixel points of the curve plotted the image.

In some embodiments, determining a three-dimensional path points set based on at least one of the altitude of the imaging device relative to the ground when the imaging device captures the image, the angle of the imaging device relative to the ground, the coordinates of each pixel point of the curve in a coordinate system associated with the image, or the focal length of the imaging device may include the following steps:

1) determining a back-projection point on the ground for each pixel point, the back-projection point being a crossing point between the ground and a ray formed from an optical center of a lens of the imaging device to the pixel point.

2) determining coordinates of the back-projection point in a camera coordinate system based on the coordinates of the pixel point in the image coordinate system associated with the image, and the focal length of the imaging device.

In some embodiments, based on the coordinates (u, v) of pixel point N in the image coordinate system associated with the specific image 20, the coordinates (u0, v0) of point 01 in the image coordinate system associated with the specific image 20, the focal length f of the imaging device, the altitude (or height) H of the imaging device relative to the ground, a processor may determine the coordinate x in the camera coordinate system for the back-projection point P of the pixel point N on the specific curve 21-22 based on the following equation (1):

x=k(u−u0, v−v0, f)^{T} (1)

In the above equation, k is a parameter of depth of view of a characteristic plane image. The parameter k may be related to the height H of the imaging device relative to the ground. In some embodiments, the larger the height H of the imaging device relative to the ground, the larger the parameter k.

3) determining coordinates of the back-projection point in the ground coordinate system based on the coordinates of the back-projection point in the camera coordinate system.

In some embodiments, determining coordinates of the back-projection point in the ground coordinate system based on the coordinates of the back-projection point in the camera coordinate system may include, or may be implemented as, the following steps: determining external parameters of the camera coordinate system relative to the ground coordinate system based on the altitude of the imaging device when the imaging device captures the specific image, and the angle of the imaging device relative to the ground; determining the coordinates of the back-projection point in the ground coordinate system based on the coordinates of the back-projection point in the camera coordinate system, and the external parameters of the camera coordinate system relative to the ground coordinate system.

In some embodiments, there is a conversion relationship between the camera coordinate system and the ground coordinate system. For example, the relationship between the camera coordinate system and the ground coordinate system may be expressed by a rotation matrix R and a translation vector t. In some embodiments, the rotation matrix R and the translation vector t are the external parameters of the camera coordinate system relative to the ground coordinate system. In some embodiments, the rotation matrix and the translation vector t may be expressed in the following equations (2) and (3):

$$\begin{matrix}R ( - θ ) = ( \begin{matrix}1 & 0 & 0 \\ 0 & cos θ & - sin θ \\ 0 & sin θ & cos θ\end{matrix} ) & ( 2 ) \\ t = ( \begin{matrix}0 \\ 0 \\ H\end{matrix} ) & ( 3 )\end{matrix}$$

In the above equations (2) and (3), H represents the height (or altitude) of the imaging device relative to the ground. In some embodiments, the height of the imaging device relative to the ground can be approximated by the height of the optical center 0 of the lens of the imaging device relative to the ground. The parameter θ represents the pitch angle of the imaging device relative to the ground.

Based on equations (1), (2), and (3), the coordinates of the back-projection point in the camera coordinate system may be converted into coordinates in the ground coordinate system. The coordinates of the back-projection point in the ground coordinate system may be expressed by equation (4):

x=kR(−θ)(u−u₀, v−v₀, f)^{T}+t (4)

In equation (4), assuming the coordinate in the z-axis is x_{z}=0, and k is obtained through other computation, if the value of k is input into equation (4), the coordinates of the back-projection point in the ground coordinate system can be calculated.

In some embodiments, based on the same processes discussed above in connection with the back-projection point P, the processor can calculate the coordinates of the back-projection point in the ground coordinate system for any pixel point on the specific curve 21-22 that is plotted on the specific image 20. The present disclosure does not limit the shape of the specific curve 21-22.

4) determining the three-dimensional point in the ground coordinate system for the pixel point on the specific curve 21-22 based on the altitude of the imaging device when the imaging device captures the specific image, and the coordinates of the back-projection point in the ground coordinate system.

In some embodiments, after determining the coordinates in the ground coordinate system for the back-projection of any pixel point on the specific curve 21-22 plotted in the specific image 20, the processor may translate the back-projection point to the altitude of the UAV in the ground coordinate system, thereby obtaining the three-dimensional coordinate point corresponding to each pixel point in the three-dimensional space, e.g., the ground coordinate system. Because the three-dimensional coordinate points are points that form the flight path of the UAV, the present disclosure regards the three-dimensional coordinate points as three-dimensional path points. The three-dimensional path points corresponding to the pixel points on the specific curve 21-22 form the three-dimensional path points set.

In step S203, the processor generates the flight path based on the three-dimensional path points set.

In some embodiments, three-dimensional flight path may be generated based on the three-dimensional path points set and a path generating algorithm. The three-dimensional flight path generated by the path generating algorithm can satisfy the kinematic constraints of the UAV. The path generating algorithm can be any suitable algorithm that can generate a flight path based on multiple flight path points. In some embodiments, the path generating algorithm may be an algorithm based on minimum snap. The three-dimensional flight path generated using the algorithm based on the minimum snap can not only satisfy the kinematic constraints of the UAV, but also satisfy the constraints on the smoothness.

In some embodiments, the three-dimensional flight path may be configured for controlling the flight of the UAV, such as controlling the UAV to fly along the three-dimensional flight path. In some embodiments, the three-dimensional flight path is the flight path that the UAV follows.

Embodiments of the present disclosure determine the back-projection point on the ground (e.g., in the ground coordinate system) for each pixel point on the specific curve based on the optical center of the lens of the imaging device and the pixel point. Embodiments of the present disclosure also determine the coordinates of the back-projection point in the cameral coordinate system based on at least one of the altitude of the imaging device, the angle of the imaging device relative to the ground, and the focal length of the imaging device. Embodiments of the present disclosure also determine the external parameters of the camera coordinate system relative to the ground coordinate system. Embodiments of the present disclosure also determine the coordinates of the back-projection point in the ground coordinate system based on the coordinates of the back-projection point in the cameral coordinate system, and the external parameters of the cameral coordinate system relative to the ground coordinate system. Embodiments of the present disclosure also accurately determine coordinates of a three-dimensional path point based on the coordinates of the back-projection point in the ground coordinate system. The present disclosure enables accurate determination of three-dimensional path, e.g., three-dimensional flight path, thereby enabling more accurate control of the UAV.

Embodiments of the present disclosure provide a method of generating a flight path. FIG. 3 is a flow chart illustrating an example method of generating a flight path. FIG. 3A is a schematic illustration of three-dimensional path points in accordance with an embodiment of the present disclosure. FIG. 3B is a schematic illustration of three-dimensional path points in accordance with another embodiment of the present disclosure. FIG. 3C is a schematic illustration of three-dimensional path points in accordance with another embodiment of the present disclosure. FIG. 3D is a schematic illustration of three-dimensional path points in accordance with another embodiment of the present disclosure. As shown in FIG. 3, based on the embodiments shown in FIG. 2, the method of generating a flight path based on three-dimensional path points set includes the following steps that may be executed by any processor disclosed herein.

In step S301, a processor pre-processes the three-dimensional points set to generate pre-processed three-dimensional points set.

Due to the arbitrariness of the specific curve drawn by a user, the specific curve does not necessarily satisfy the kinematic constraints of the UAV. Therefore, the three-dimensional path points or three-dimensional path points set is pre-processed. Pre-processing the three-dimensional path points (or points set) renders the three-dimensional points (or points set) satisfying the kinematic constraints of the UAV. In some embodiments, methods for pre-processing the three-dimensional path points may include at least one of the following methods:

1) The processor obtains a maximum flight distance of the UAV and pre-processes the three-dimensional path points set based on the maximum flight distance.

In some embodiments, the processor calculates a length of the three-dimensional path formed by the three-dimensional path points set. If the length of the three-dimensional path formed by the three-dimensional path points set is greater than the maximum flight distance, the processor may remove one or more three-dimensional path points from the three-dimensional path points set, such that the length of the three-dimensional path formed by the remaining three-dimensional path points is smaller than the maximum flight distance of the UAV.

In some embodiments, each three-dimensional path point has corresponding three-dimensional coordinates in the ground coordinate system. Based on the three-dimensional coordinates of each three-dimensional path point, the processor may calculate a distance between two adjacent three-dimensional path points. The sum of the distances between every two adjacent three-dimensional path points is the total length of the three-dimensional path formed by the three-dimensional path points set. Because the maximum flight distance of the UAV is limited, if the total length of the three-dimensional path is greater than the maximum flight distance of the UAV, the processor may limit the distance that the UAV travels or flies. In some embodiments, limiting the distance the UAV travels or flies may include removing one or more of the three-dimensional path points from the three-dimensional path points set. For example, the three-dimensional path points at the beginning or at the end of the three-dimensional path points set may be removed. In some embodiments, in a predetermined range of the three-dimensional path points set, the processor may remove one or two three-dimensional path points at every other one three-dimensional path point, such that the total length of the three-dimensional path formed by the remaining three-dimensional path points in the three-dimensional path points set is smaller than or equal to the maximum flight distance of the UAV. In some embodiments, the maximum flight distance of the UAV may be a curved distance of a curved three-dimensional flight path along which the UAV flies. In some embodiments, the maximum flight distance of the UAV may be a straight distance between a starting three-dimensional path point and an ending three-dimensional path point.

2) The processor obtains a density of at least partially continuous three-dimensional path points included in the three-dimensional path points set, and pre-processes the at least partially continuous three-dimensional path points based on the density.

In some embodiments, the processor may determine the number of three-dimensional path points located within a predetermined range of the three-dimensional path points set. If the number of the three-dimensional path points located within the predetermined range is greater than a predetermined value, the processor may reduce the number of the three-dimensional path points within the predetermined range. Alternatively, the processor may obtain substitute points located within the predetermined range. The processor may replace the three-dimensional path points located within the predetermined range with the substitute points. If the number of the three-dimensional path points located within the predetermined range is smaller than or equal to the predetermined value, the processor may increase the number of three-dimensional path points located within the predetermined range. That is, the processor may increase the number of three-dimensional path points in a local range or area of the three-dimensional path points set that has a low density.

In some embodiments, when a user draws the specific curve, the pixel points at the beginning portion of the specific curve may have a relatively high density. For example, there may be multiple pixel points in a small distance. In turn, the three-dimensional path points in the ground coordinate system, which correspond to the pixel points at the beginning portion of the specific curve, may also have a relatively high density. In order to determine the density of the three-dimensional path points in the ground coordinate system, the present disclosure may determine the number of three-dimensional path points in the ground coordinate system, which are located within a predetermined range. If the number of three-dimensional path points located within the predetermined range is greater than a predetermined value, the processor may reduce the number of three-dimensional path points located within the predetermined range. Alternatively, the processor may obtain substitute points located within the predetermined range, and replace the three-dimensional path points located within the predetermined range with the substitute points. The substitute points may include one or more three-dimensional path points located within the predetermined range. In some embodiments, the substitute points may include a center point or center of gravity of a geometrical shape formed by connecting all of the three-dimensional path points located within the predetermined range. In some embodiments, the substitute points may be a center point or center of gravity of a geographical shape formed by connecting part of the three-dimensional path points located within the predetermined range.

3) The processor obtains a degree of jittering of a specific three-dimensional path point in the three-dimensional path points set, and pre-processes the specific three-dimensional path point based on the degree of jittering.

For example, if the degree of jittering of the specific three-dimensional path point is smaller than a predetermined value, the processor may remove the specific three-dimensional path point. Alternatively or additionally, if the degree of jittering of the specific three-dimensional path point is greater than or equal to the predetermined value, the processor may keep the specific three-dimensional path point.

In some embodiments, the degree of jittering of the specific three-dimensional path point is determined based on a length of a straight line that runs through a first three-dimensional path point that is subsequent to the specific three-dimensional path point, the specific three-dimensional path point, and a second three-dimensional path point that is prior to the specific three-dimensional path point.

For example, when a user draws the specific curve, the hand of the user may shake, causing jittering in the three-dimensional path points. As a result, the specific curve drawn by the user may have multiple segments that are bent away from other segments. To reduce the degree of jittering of the specific curve, the present disclosure removes the three-dimensional path points that have relatively small jittering.

As shown in FIG. 3A, points A, B, C, and D are three-dimensional path points in the ground coordinate system corresponding to four adjacent pixel points on the specific curve. Point A is a three-dimensional path point that is prior the point B. Point C is a three-dimensional path point that is subsequent to point B. Point B is a three-dimensional path point prior to point C. Point D is a three-dimensional point subsequent to point C. A perpendicular line can be drawn from point C toward the straight line connecting point A and point B. The perpendicular line crosses an extended line of line AB at point C1. A distance between points C and C1 may be used to represent a degree of jittering of point B. If the distance between points C and C1 is smaller than a predetermined value, it indicates that the degree of jittering of three-dimensional path point B is smaller than the predetermined value. The processor may remove point B. If the distance between points C and C1 is greater than or equal to the predetermined value, the processor may keep the three-dimensional path point B. In some embodiments, assuming that the distance between points C and C1 is smaller than the predetermined value, as shown in FIG. 3B, the processor may remove the three-dimensional point B.

As shown in FIG. 3B, after removing point B, if a straight line is drawn from point D perpendicular to a straight line connecting point A and point C, the perpendicular line crosses an extended line of the straight line AC at point D1. A distance between point D and point D1 can be used to represent the degree of jittering of point C. If the distance between point D and point D1 is smaller than a predetermined value, it indicates that the degree of jittering of three-dimensional path point C is smaller than the predetermined value. As a result, point C can be removed. If the distance between point D and point D1 is greater than or equal to the predetermined value, the processor may keep three-dimensional path point C. For example, in one embodiment, if the distance between point D and point D1 is greater than a predetermined value, then three-dimensional path point C is kept. The three-dimensional path point C may be a starting point. The degree of jittering of each point subsequent to point C can be determined in a similar manner, until the degrees of jittering for all of the three-dimensional path points are determined.

4) The processor may generate a three-dimensional path based on a plurality of at least partially continuous three-dimensional path points included in the three-dimensional path points set, and pre-process the plurality of at least partially continuous three-dimensional path points based on a curvature of the three-dimensional path.

In some embodiments, if a curvature of the three-dimensional path at a first three-dimensional path point is greater than a predetermined value, the processor may obtain a substitute point. In some embodiments, the first three-dimensional path point is one of the at least partially continuous three-dimensional points. A local curve can be formed by the substitute point, the first three-dimensional path point, and the two three-dimensional path points prior to and subsequent to the first three-dimensional path point. When the curvature of the local curve is smaller than a curvature of the three-dimensional path at the first three-dimensional path point, the first three-dimensional path point may be replaced by the substitute point.

In some embodiments, the substitute point may be obtained as follows. First, a first intermediate point is obtained. The first intermediate point is located between the first three-dimensional path point and a three-dimensional path point that is prior to the first three-dimensional path point. A second intermediate point is obtained. The second intermediate point is located between the first three-dimensional path point and a three-dimensional path point that is subsequent to the first three-dimensional path point. The substitute point may include the first intermediate point and the second intermediate point.

In some embodiments, the substitute point may be obtained as follows. First, the first three-dimensional path point, a three-dimensional path point prior to the first three-dimensional path point, and a three-dimensional path point subsequent to the first three-dimensional path point may be connected to form a triangle. The center point or the center of gravity of the triangle may be used as the substitute point.

In some embodiments, when the UAV makes a turn, the adjustment to the turning angle may be limited. If the curvature of the curve formed by the three-dimensional path points is relatively large, the UAV may not be able to fly along the flight path. Accordingly, when pre-processing the three-dimensional path points, those points where the curve has a large curvature are removed, such that the flight path becomes smooth. As a result, the UAV can fly along a smooth flight path.

As shown in FIG. 3C, points A, B, and C are three adjacent three-dimensional path points. Point A is a three-dimensional point prior to point B. Point C is a three-dimensional point subsequent to point B. If points A, B, and C are connected using a smooth curve, based on related mathematical formulas, the curvature of the curve ABC at point B can be calculated. If the curvature at point B is greater than a predetermined value, point B is removed. If the curvature of the curve ABC at point B is smaller than the predetermined value, point B is kept. As shown in FIG. 3C, the curvature of curve ABC at point B is relatively large, and the curve ABC at point B is relatively steep, making curve ABC not smooth. As such, in order to make the UAV to fly along a smooth flight path, the processor may obtain a substitute point to replace point B. As a result, the curve formed by point A, point C, and the substitute point (that replaces point B) has a curvature at the substitute point that is smaller than the curvature of the curve ABC at point B. In some embodiments, the substitute point may be one point or multiple points.

In some embodiments, if point D is a middle point of line segment AB, and point E is a middle point of line segment BC, point B may be replaced by point D and point E, and point B may be removed. The curve ADEC formed by point A, point D, point E, and pint C is smoother than curve ABC.

In some embodiments, as shown in FIG. 3D, points A, B, and C may form a triangle. The center point or the center of gravity G may be used as a substitute point to replace point B. The curve formed by the point A, point C, and the center point or the center of gravity G has a curvature at the center point or the center of gravity G that is smaller than the curvature of curve ABC at point B.

The above processes for determining the curvature and for pre-processing can be also applied to other three-dimensional path points other than points A, B, and C.

In step S302, the processor determines the flight path using a flight path generating algorithm based on the pre-processed three-dimensional path points set, the flight path satisfying kinematic constraints of the UAV.

After being pre-processed, the pre-processed three-dimensional path points set is generated. For the pre-processed three-dimensional path points, the processor can use a flight path generating algorithm to generate a flight path that satisfies the kinematic constraints of the UAV. In some embodiments, the path generating algorithm may be an algorithm based on minimum snap. The three-dimensional flight path generated using the algorithm based on the minimum snap can not only satisfy the kinematic constraints of the UAV, but also satisfy the constraints on the smoothness.

In some embodiments, when the UAV flies along the flight path, the processor may detect whether there is an obstacle in front of the UAV along the flight path. If there is an obstacle in front of the UAV along the flight path, an obstacle avoidance function may be activated. After the UAV avoids the obstacle, the processor may control the UAV to resume flight along the flight path (e.g., control the UAV to return to the flight path).

After obtaining the flight path that satisfies the kinematic constraints and the constraints on the smoothness, the flight control device may control the UAV to fly along the flight path. When the UAV flies along the flight path, the radar installed on the UAV may detect whether there is an obstacle in front of the UAV along the flight path. If there is an obstacle in front of the UAV along the flight path, the flight control device may activate an obstacle avoidance function of the UAV. After the UAV avoids the obstacle, the flight control device may control the UAV to resume flight along the flight path.

The present disclosure pre-processes each three-dimensional path point in the three-dimensional path points set, prior to generating the flight path. One of the objectives of pre-processing the three-dimensional path points is to ensure that the flight path generated based on the pre-processed three-dimensional path points can satisfy the kinematic constraints. The present disclosure solves the problem caused by the arbitrariness of the specific curve drawn by the user, which renders the specific curve not satisfying the kinematic constraints. When the UAV flies along the flight path, the radar installed on the UAV can detect whether there is an obstacle in front of the UAV along the flight path. If there is an obstacle, the obstacle avoidance function of the UAV may be activated to avoid the obstacle. After the UAV avoids the obstacle, the flight control device may control the UAV to resume the flight path (e.g., continue to fly along the flight path), thereby enhancing the safety of the UAV.

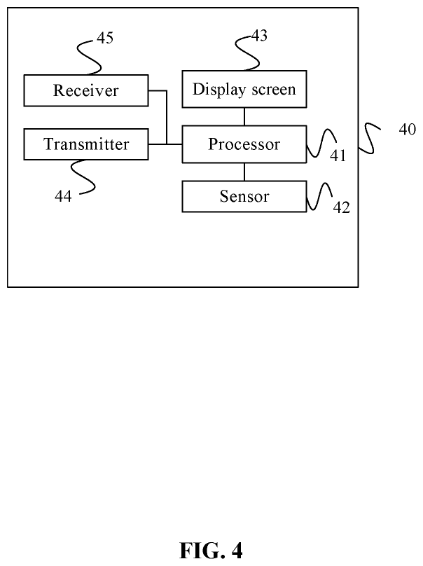

The present disclosure provides a control device. FIG. 4 is a schematic diagram showing an example control device. As shown in FIG. 4, a control device 40 includes one or more processors 41, operating individually or in collaboration. The control device 40 also includes a sensor 42. The one or more processors 41 may be configured or programmed to obtain the specific image and the specific curve, the specific curve being a curve plotted on the specific image. The one or more processors 41 may also be configured to generate a flight path based on the specific curve and the specific image. The flight path may be configured for controlling the UAV to fly along the flight path.

In some embodiments, the control device 40 is a ground station or a flight control device.

When the control device is a ground station, or is included in the ground station, the control device 40 may include a transmitter 44 communicatively coupled with the one or more processors 41, the transmitter 44 being configured to transmit or send the flight path to the UAV.

When the control device is the flight control device, or is included in the flight control device, the control device may include a receiver communicatively coupled with the one or more processors, the receiver being configured to receive the flight path transmitted by the ground station. The one or more processors may be configured or programmed to control the UAV to fly along the flight path.

In some embodiments, when the control device 40 is a ground station or is included in the ground station, the one or more processors 41 may be configured or programmed to obtain real time images captured by the imaging device carried by the UAV. The control device 40 includes a display screen 43 configured to display the real time images. The display screen 43 is also configured to sense or detect the specific curve plotted on the real time image(s) displayed on the display screen 43. In some embodiments, the one or more processors 41 may be configured to obtain the specific curve and the specific image. The specific image may include at least part of the real time image(s) onto which the specific curve is plotted.

The one or more processors 41 may be configured to obtain the specific curve and the specific image through at least one of the following methods:

1) the one or more processors 41 downloads (or retrieves, obtains) the specific image and the specific curve from a cloud platform;

2) when the control device 40 is a first ground station, or is included in the first ground station, the control device 40 includes one or more processors 41 communicatively coupled with a receiver 45, the receiver 45 being configured to receive the specific image and the specific curve transmitted by a second ground station.

The operating principles and methods implemented by the flight control device are the same as those described in connection with FIG. 1, which are not repeated.

The present disclosure plots the specific curve on the specific image, and generates the flight path based on the specific curve for controlling the flight of the UAV. The specific curve may be a specific curve drawn by a user on a still image, or may be a specific curve drawn by the user on one or multiple image frames of a dynamic video. Correspondingly, the specific image may be a still image, or may include one or multiple image frames of a dynamic video. A user may draw the specific curve on the specific image, the specific curve being used or configured to control the flight path of the UAV. The UAV may fly along a customized specific curve. Thus, the present disclosure enables customization of flight mode for the UAV. Compared to the conventional technology used in target tracking mode and intelligent follow mode, the present disclosure provides enhanced flexibility of the flight mode for UAV.

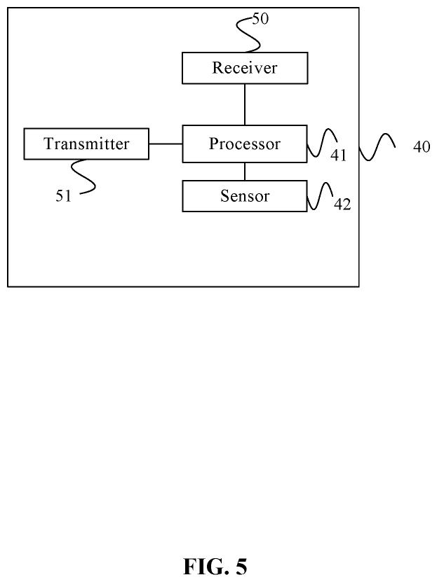

The present disclosure provides a control device. FIG. 5 is a schematic diagram of a control device according to another embodiment. The control device 40 is a flight control device, or is included in the flight control device. The control device 40 includes one or more processors 41, operating individually or in collaboration. In some embodiments, the control device 40 includes a sensor. In some embodiments, the control device includes a receiver 50 communicatively coupled with the one or more processors 41. The receiver 50 may be configured to receive the specific image and the specific curve transmitted from the ground station. In some embodiments, the one or more processors 41 may be configured to control the UAV to fly along the flight path. In some embodiments, the one or more processors 41 may be configured to obtain the specific image and the specific curve from the ground station, or the one or more processors 41 may retrieve, download, or obtain the specific image and the specific curve from a cloud platform.

In some embodiments, the control device 40 may include a transmitter 51 communicatively coupled with the one or more processors 41. The transmitter may be configured to transmit the real time images captured by the imaging device carried by the UAV to the ground station.

In some embodiments, the one or more processors 41 may be configured to obtain the specific image and the specific curve by: obtaining at least one of the altitude of the imaging device relative to the ground when the imaging device captures the specific image, the angle of the imaging device relative to the ground, the coordinates of the each pixel point on the specific curve in the image coordinate system associated with the specific image, or the focal length of the imaging device. In some embodiments, the one or more processors 41 may generate a flight path based on the specific image and the specific curve by: determining three-dimensional path points set based on at least one of the altitude of the imaging device relative to the ground when the imaging device captures the specific image, the angle of the imaging device relative to the ground, the coordinates of each pixel point on the specific curve in the image coordinate system associated with the specific image, and the focal length of the imaging device, the three-dimensional path points set including three-dimensional path points in a ground coordinate system corresponding to pixel points, the pixel points being pixel points of the curve plotted on the image; and generating the flight path based on the three-dimensional path points set.

In some embodiments, the one or more processors 41 may generate the flight path based on the three-dimensional path points set by: pre-processing the three-dimensional path points set to generate pre-processed three-dimensional path points set; and determining the flight path using a flight path generating algorithm based on the pre-processed three-dimensional path points set, the flight path satisfying kinematic constraints of the UAV.

In some embodiments, the one or more processors 41 may pre-process the three-dimensional path points set by at least one of the following methods:

1) The one or more processors 41 obtain a maximum flight distance of the UAV and pre-processes the three-dimensional path points set based on the maximum flight distance.

In some embodiments, the one or more processors 41 pre-processing the three-dimensional path points set based on the maximum flight distance may include: calculating a length of the three-dimensional path formed by the three-dimensional path points set. If the length of the three-dimensional path formed by the three-dimensional path points set is greater than the maximum flight distance, the one or more processors may delete or remove one or more three-dimensional path points from the three-dimensional path points set, such that the length of the three-dimensional path formed by the remaining three-dimensional path points is smaller than maximum flight distance of the UAV.

2) The one or more processors 41 obtain a density of at least partially continuous three-dimensional path points included the three-dimensional path points set, and pre-process the at least partially continuous three-dimensional path points based on the density.

In some embodiments, the one or more processors 41 pre-process the at least partially continuous three-dimensional path points based on the density may include: determining the number of three-dimensional path points located within a predetermined range of the three-dimensional path points set. If the number of the three-dimensional path points located within the predetermined range is greater than a predetermined value, the one or more processors may reduce the number of the three-dimensional path points within the predetermined range. Alternatively, the one or more processors may obtain substitute points located within the predetermined range. The one or more processors may replace the three-dimensional path points located within the predetermined range with the substitute points.

3) The one or more processors 41 obtain a degree of jittering of a specific three-dimensional path point in the three-dimensional path points set, and pre-process the specific three-dimensional path point based on the degree of jittering.

In some embodiments, the one or more processors 41 pre-processing the specific three-dimensional path point based on the degree of jittering may include: if the degree of jittering of the specific three-dimensional path point is smaller than a predetermined value, the one or more processors 41 may remove the specific three-dimensional path point. Alternatively or additionally, if the degree of jittering of the specific three-dimensional path point is greater than or equal to the predetermined value, the one or more processors 41 may keep the specific three-dimensional path point.

In some embodiments, the degree of jittering of the specific three-dimensional path point is determined based on a distance of a straight line between a first three-dimensional path point that is subsequent to the specific three-dimensional path point and a second three-dimensional path point that is prior to the specific three-dimensional path point.

4) The one or more processors 41 may generate the three-dimensional path based on the at least partially continuous three-dimensional path points in the three-dimensional path points set. The one or more processors 41 may also pre-process the at least partially continuous three-dimensional path points based on a curvature of the three-dimensional path.

In some embodiments, the one or more processors 41 pre-processing the at least partially continuous three-dimensional path points based on a curvature of the three-dimensional path may include: if the three-dimensional path has a curvature at a first three-dimensional path point that is greater than a predetermined value, the processor may obtain a substitute point. In some embodiments, the first three-dimensional path point may be one of the at least partially continuous three-dimensional points. A local curve can be formed by the substitute point, the first three-dimensional path point, and the two three-dimensional path points prior to and subsequent to the first three-dimensional path point. The curvature of the local curve may be smaller than a curvature of the three-dimensional path at the first three-dimensional path point. When the curvature of the local curve is smaller than the curvature of the three-dimensional path at the first three-dimensional path point, the first three-dimensional path point may be replaced by the substitute point.

In some embodiments, the one or more processors 41 obtaining the substitute points may include: obtaining a first intermediate point located between the first three-dimensional path point and a three-dimensional path point that is prior to the first three-dimensional path point. A second intermediate point is obtained. The one or more processors 41 may also obtain a second intermediate point located between the first three-dimensional path point and a three-dimensional path point that is subsequent to the first three-dimensional path point. The substitute point may include the first intermediate point and the second intermediate point.

In some embodiments, the substitute point may be obtained as follows. First, the first three-dimensional path point, a three-dimensional path point prior to the first three-dimensional path point, and a three-dimensional path point subsequent to the first three-dimensional path point may be connected to form a triangle. The center point or the center of gravity of the triangle may be used as the substitute point.

The principle of operation and the methods implemented in the flight control device are the same or similar to those discussed above in connection with FIG. 3, which are not repeated.

Based on the three-dimensional path points set, and before generating the flight path, the one or more processors 41 may pre-process each three-dimensional path point included in the three-dimensional path points set. One of the objectives of pre-processing the three-dimensional path points is to ensure that the flight path generated based on the pre-processed three-dimensional path points can satisfy the kinematic constraints. The present disclosure solves the problem caused by the arbitrariness of the specific curve drawn by the user, which renders the specific curve not satisfying the kinematic constraints. When the UAV flies along the flight path, the radar installed on the UAV can detect whether there is an obstacle in front of the UAV along the flight path. If there is an obstacle, the obstacle avoidance function of the UAV may be activated to avoid the obstacle. After the UAV avoids the obstacle, the flight control device may control the UAV to resume the flight path (e.g., continue to fly along the flight path), thereby enhancing the safety of the UAV.

The present disclosure provides a control device. According to the embodiment shown in FIG. 5, one or more processors 41 generating the three-dimensional path points set based on at least one of an altitude of the imaging device relative to the ground when the imaging device captures the specific image, an angle of the imaging device relative to the ground, coordinates of each pixel point on the specific curve in the image coordinate system associated with the specific image, or a focal length of the imaging device, may include the following steps: determining a back-projection point on the ground for each pixel point, the back-projection point being a crossing point between the ground and a ray formed from an optical center of a lens of the imaging device to the pixel point; determining coordinates of the back-projection point in a camera coordinate system based on the coordinates of the pixel point in the image coordinate system associated with the specific image, and the focal length of the imaging device; determining coordinates of the back-projection point in the ground coordinate system based on the coordinates of the back-projection point in the camera coordinate system; and determining the three-dimensional path point corresponding to the pixel point in the ground coordinate system based on the altitude of the imaging device relative to the ground when the imaging device captures the image, and the coordinates of the back-projection point in the ground coordinate system.

In some embodiments, determining the coordinates of the back-projection point in the ground coordinate system based on the coordinates of the back-projection point in the camera coordinate system may include the following steps: determining external parameters of the camera coordinate system relative to the ground coordinate system based on the altitude of the imaging device when the imaging device captures the specific image, and the angle of the imaging device relative to the ground; determining the coordinates of the back-projection point in the ground coordinate system based on the coordinates of the back-projection point in the camera coordinate system, and the external parameters of the camera coordinate system relative to the ground coordinate system.

In some embodiments, the flight path generating algorithm may include an algorithm based on minimum snap.

As shown in FIG. 5, the sensor 42 may be communicatively coupled with the one or more processors 41. The sensor 42 may be configured to detect (or sense) whether there is an obstacle in front of the UAV on the flight path, and send a result of the detection to the one or more processors 41. The one or more processors 41 may determine, based on the result of the detection, whether there is an obstacle in front of the UAV on the flight path. If there is an obstacle in front of the UAV on the flight path, the one or more processors 41 may control the UAV to avoid (e.g., circumvent) the obstacle. After the UAV avoids (e.g., circumvents) the obstacle, the one or more processors 41 may control the UAV to resume the flight path.

In some embodiments, the detailed principle of operation and methods implemented by the flight control device are the same as or similar to those discussed above in connection with FIG. 2, which are not repeated.

Embodiments of the present disclosure determine the back-projection point on the ground (e.g., in the ground coordinate system) for each pixel point on the specific curve based on the optical center of the lens of the imaging device and the pixel point. Embodiments of the present disclosure also determine the coordinates of the back-projection point in the cameral coordinate system based on the altitude of the imaging device relative to the ground, the angle of the imaging device relative to the ground, and the focal length of the imaging device. Embodiments of the present disclosure also determine the external parameters of the camera coordinate system relative to the ground coordinate system. Embodiments of the present disclosure also determine the coordinates of the back-projection point in the ground coordinate system based on the coordinates of the back-projection point in the cameral coordinate system, and the external parameters of the cameral coordinate system relative to the ground coordinate system. Embodiments of the present disclosure also accurately determine coordinates of a three-dimensional path point based on the coordinates of the back-projection point in the ground coordinate system. The present disclosure enables accurate determination of three-dimensional path, e.g., three-dimensional flight path, thereby enabling more accurate control of the UAV.

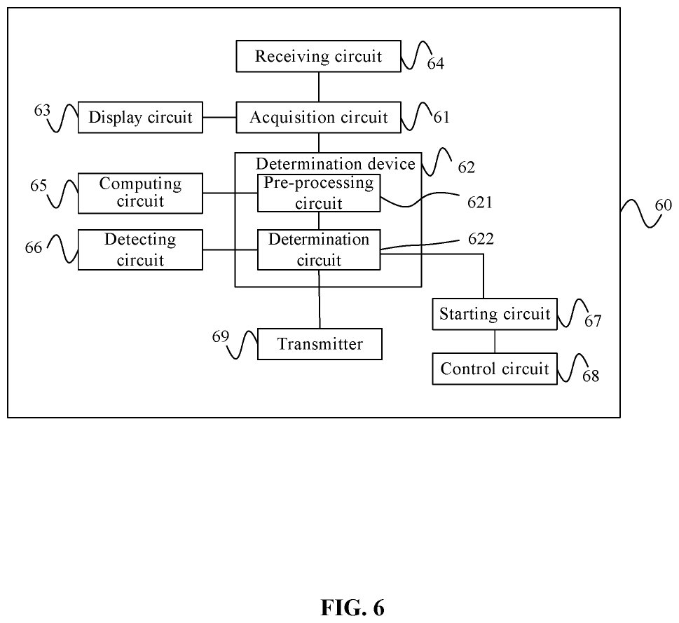

The present disclosure provides a control device. FIG. 6 is a schematic diagram of a control device according to another embodiment of the present disclosure. As shown in FIG. 6, a control device 60 includes an acquisition circuit 61 and a determination circuit 62. The acquisition circuit 61 may be configured to obtain the specific image and the specific curve, which is plotted on the specific image. The determination circuit 62 may be configured or programmed to generate a flight path based on the specific image and the specific curve, the flight path being configured for controlling the UAV to fly along the flight path.

In some embodiments, the acquisition circuit 61 may be configured to acquire real time images captured by the imaging device carried by the UAV. The control device may further include a display circuit 63 and a receiving circuit 64. The display circuit 63 may be configured to display the real time images. The receiving circuit 64 may be configured to receive the specific curve drawn or plotted on one or more of the real time images. The acquisition circuit 61 may also be configured to obtain the specific image, the specific image including at least part of the real time images onto which the specific curve is plotted or drawn.

In some embodiments, the acquisition circuit 61 may be configured to download or retrieve the specific image and the specific curve from a cloud platform. In some embodiments, the control device may be a first ground station. The receiving circuit 64 may be configured to receive the specific image and the specific curve from a second ground station.

In some embodiments, when the acquisition circuit 61 obtains the specific image and the specific curve, the acquisition circuit 61 may be configured to obtain at least one of the altitude of the imaging device relative to the ground when the imaging device captures the specific image, the angle of the imaging device relative to the ground, the coordinates of each pixel point on the specific curve in the image coordinate system associated with the specific image, or the focal length of the imaging device. The determination circuit 62, when generating the flight path based on the specific image and the specific curve, may be configured to determine a three-dimensional path points set based on at least one of the altitude of the imaging device relative to the ground when the imaging device captures the specific image, the angle of the imaging device relative to the ground, the coordinates of each pixel point on the specific curve in the image coordinate system associated with the specific image, or the focal length of the imaging device. The three-dimensional path points set may include three-dimensional path points in a ground coordinate system corresponding to pixel points, the pixel points being pixel points of the specific curve plotted on the specific image.

In some embodiments, the determination device 62 includes a pre-processing circuit 621 and a determination circuit 622. The determination device 62, when generating the flight path based on the three-dimensional path points set, pre-process the three-dimensional path points set using the pre-processing circuit 621, to obtain pre-processed three-dimensional path points set. The determination circuit 622 may be configured to generate the flight path based on the pre-processed three-dimensional path points set and a path generating algorithm. The flight path satisfies the kinematic constraints on the UAV.

When the pre-processing circuit 621 pre-processes the three-dimensional path points set, the acquisition circuit 61 is also configured to: obtain a maximum flight distance of the UAV and pre-process the three-dimensional path points set based on the maximum flight distance; obtain a density of at least partially continuous three-dimensional path points from the three-dimensional path points set, and pre-process the at least partially continuous three-dimensional path points based on the density; obtain a degree of jittering of a specific three-dimensional path point in the three-dimensional path points set. The pre-processing circuit 621 may be configured to: pre-process the three-dimensional path points set based on the maximum flight distance; pre-process at least partially continuous three-dimensional path points based on the density; pre-process the specific three-dimensional path point based on the degree of jittering; generate a three-dimensional path based on a plurality of at least partially continuous three-dimensional path points included in the three-dimensional path points set, and pre-process the plurality of at least partially continuous three-dimensional path points based on a curvature of the three-dimensional path.

In some embodiments, the control device 60 includes a computing circuit 65. When the pre-processing circuit 621 pre-processes the three-dimensional path points set based on the maximum flight distance, the computing circuit 65 may be configured to compute (or calculate, determine) a length of the three-dimensional path formed by the three-dimensional path points set. If the length of the three-dimensional path formed by the three-dimensional path points set is greater than the maximum flight distance, the pre-processing circuit 621 may be configured to remove one or more three-dimensional path points from the three-dimensional path points set, such that a length of a three-dimensional path formed by the remaining three-dimensional path points in the three-dimensional path points set is smaller than the maximum flight distance of the UAV.

In some embodiments, when the pre-processing circuit 621 pre-processes the at least partially continuous three-dimensional path points based on the density, the determination circuit 622 may be configured to determine a number of three-dimensional path points located within a predetermined range of the three-dimensional path points set. If the number of the three-dimensional path points located within the predetermined range is greater than a predetermined value, the pre-processing circuit 621 may reduce the number of the three-dimensional path points within the predetermined range. Alternatively, the acquisition circuit 61 may obtain substitute points located within the predetermined range. The pre-processing circuit 621 may replace the three-dimensional path points located within the predetermined range with the substitute points.

In some embodiments, the pre-processing circuit 621 pre-processes a specific three-dimensional path point based on a degree of jittering. If the degree of jittering of the specific three-dimensional path point is smaller than a predetermined value, the pre-processing circuit 621 may remove the specific three-dimensional path point. Alternatively or additionally, if the degree of jittering of the specific three-dimensional path point is greater than or equal to the predetermined value, the pre-processing circuit 621 may keep the specific three-dimensional path point. In some embodiments, the degree of jittering of the specific three-dimensional path point is determined based on a length of a straight line that runs through a first three-dimensional path point that is subsequent to the specific three-dimensional path point, the specific three-dimensional path point, and a second three-dimensional path point that is prior to the specific three-dimensional path point.

When the pre-processing circuit 621 pre-processes the at least partially continuous three-dimensional path points based on a curvature of the three-dimensional path, if a curvature of the three-dimensional path at the first three-dimensional path point is greater than a predetermined value, the acquisition circuit 61 may obtain one or more substitute points. In some embodiments, the first three-dimensional path point is a three-dimensional path point of the at least partially continuous three-dimensional path points. The substitute point and the two three-dimensional path points that are prior to and subsequent to the first three-dimensional path point may form a curve. The curvature of the curve at the substitute point is smaller than the curvature of the curve at the first three-dimensional path point. The pre-processing circuit 621 may be configured to replace the first three-dimensional path point with the substitute point. Replacing the first three-dimensional path point with the substitute point by the acquisition circuit 61 may include: obtaining a first intermediate point that is located between the first three-dimensional path point and a three-dimensional path point that is prior to the first three-dimensional path point; obtaining a second intermediate point that is located the first three-dimensional path point and a three-dimensional path point that is subsequent to the first three-dimensional path point. The substitute point may include the first intermediate point and the second intermediate point. Alternatively, the pre-processing circuit 621 may form a triangle with the first three-dimensional path point, a three-dimensional path point prior to the first three-dimensional path point, and a three-dimensional path point subsequent to the first three-dimensional path point. The center point or the center of gravity of the triangle may be used as the substitute point.

The determination device 62 may determine a three-dimensional path points set based on at least one of the altitude of the imaging device relative to the ground when the imaging device captures the specific image, the angle of the imaging device relative to the ground, the coordinates of each pixel point on the specific curve in the image coordinate system associated with the specific image, or the focal length of the imaging device. For example, the determination of the three-dimensional path points set may include: determining a back-projection point on the ground for each pixel point, the back-projection point is a crossing point between the ground and a ray formed by an optical center of a lens of the imaging device and the pixel point; determining coordinates of the back-projection point in a camera coordinate system based on the coordinates of the pixel point in the image coordinate system associated with the specific image, and the focal length of the imaging device; determining coordinates of the back-projection point in the ground coordinate system based on the coordinates of the back-projection point in the camera coordinate system; and determining the three-dimensional path point corresponding to the pixel point in the ground coordinate system based on the altitude of the imaging device relative to the ground when the imaging device captures the image, and the coordinates of the back-projection point in the ground coordinate system. The determination device 62 determining the coordinates of the back-projection point in the ground coordinate system based on the coordinates of the back-projection point in the camera coordinate system may include: determining external parameters of the camera coordinate system relative to the ground coordinate system based on the altitude of the imaging device when the imaging device captures the specific image, and the angle of the imaging device relative to the ground; determining the coordinates of the back-projection point in the ground coordinate system based on the coordinates of the back-projection point in the camera coordinate system, and the external parameters of the camera coordinate system relative to the ground coordinate system.

In some embodiments, the algorithm for generating the flight path may include an algorithm based on minimum snap.

As shown in FIG. 6, the control device 60 also includes a detecting circuit 66, a starting circuit 67, and a control circuit 68. The detecting circuit 66 may be configured to detect whether there is an obstacle in front of the UAV along the flight path, when the UAV flies along the flight path. The starting circuit 67 is configured to activate an obstacle avoidance function of the UAV when the detecting circuit 66 detects an obstacle in front of the UAV along the flight path. The control circuit 68 may be configured to control the UAV to resume the flight path after the UAV avoids the obstacle.

In some embodiments, as shown in FIG. 6, the control device 60 includes a transmitter 69 configured to transmit or upload the flight path to a specific server. In some embodiments, the control device 60 is a ground station, and may include a transmitter, such as transmitter 69, for sending the flight path to a second station.

According to embodiments of the present disclosure, a specific curve can be drawn on a specific image. The specific curve can be used to generate a flight path for controlling the flight of the UAV. In some embodiments, the specific curve may be a curve drawn on a still image based on an input received from a user. In some embodiments, the specific curve may be a curve drawn on an image frame or multiple image frames of a dynamic video. Correspondingly, the specific image may be a still image, or an image frame or multiple image frames of a dynamic video. The specific curve drawn on the specific image by the user may be used to control the flight path of the UAV. That is, the UAV may fly along a customized specific curve. Thus, the present disclosure enables customization of the flight mode of a UAV. Compared to the conventional technology used in the target tracking mode and the intelligent follow mode, the present disclosure improves the flexibility of flight mode design for UAVs.

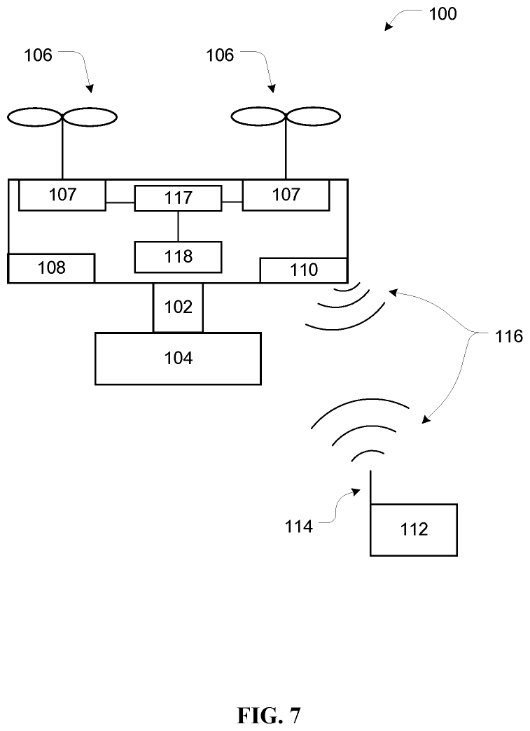

The present disclosure provides a UAV. FIG. 7 is a schematic diagram of a UAV. As shown in FIG. 7, a UAV 100 includes a body, a propulsion system, and a flight control device 118. The propulsion system includes at least one of a motor 107, a propeller 106, and an electrical speed control (“ESC”) 117. The propulsion system may be installed or mounted on the body and may be configured to provide a propulsion force for the flight. The flight control device 118 may be communicatively coupled with the propulsion system, and may be configured to control the flight of the UAV. In some embodiments, the flight control device 118 may include an inertial measurement unit or device, and/or a gyroscope. The inertial measurement unit and the gyroscope may be configured to detect at least one of an acceleration, a pitch angle, a roll angle, and a yaw angle of the UAV.

As shown in FIG. 7, the UAV 100 may include a sensor system 108, a communication system 110, a supporting apparatus 102, and an imaging device 104. The supporting apparatus 102 may include a gimbal. The communication system 110 may include a receiver configured to receive wireless signals transmitted from an antenna 114 of a ground station 112. The reference number 116 denotes an electromagnetic wave generated during the communication between the receiver and the antenna 114.

The detailed principle and methods implemented by the flight control device 118 are similar to those discussed above in connection with the control device, which are not repeated.

According to embodiments of the present disclosure, a specific curve can be drawn on a specific image. The specific curve can be used to generate a flight path for controlling the flight of the UAV. In some embodiments, the specific curve may be a curve drawn on a still image based on an input received from a user. In some embodiments, the specific curve may be a curve drawn on an image frame or multiple image frames of a dynamic video. Correspondingly, the specific image may be a still image, or an image frame or multiple image frames of a dynamic video. The specific curve drawn on the specific image by the user may be used to control the flight path of the UAV. That is, the UAV may fly along a customized specific curve. The present disclosure enables customization of the flight mode of a UAV. Compared to the conventional technology used in the target tracking mode and the intelligent follow mode, the present disclosure improves the flexibility of flight mode design for UAVs.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using interfaces. The indirect couplings or communication connections between devices or units or components may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated units may be realized using hardware, or may be realized using hardware and software functioning unit.

The integrated units realized using software functioning units may be stored in a computer-readable medium, such as a non-transitory computer-readable storage medium, including computer instructions or commands that are executable by a computing device (e.g., a personal computer, a server, or a network device, etc.) or a processor to perform various steps of the disclosed methods. The non-transitory computer-readable storage medium can be any medium that can store program codes, for example, a USB disc, a portable hard disk, a read-only memory (ROM), a random access memory (RAM), a magnetic disk, an optical disk, etc.

A person having ordinary skill in the art can appreciate that for convenience and simplicity, the above descriptions described the division of the functioning units. In practical applications, the disclosed functions may be realized by various functioning units. For example, in some embodiments, the internal structure of a device may be divided into different functioning units to realize all or part of the above-described functions. The detailed operations and principles of the device are similar to those described above, which are not repeated.

A person having ordinary skill in the art can appreciate that the above embodiments are only examples of the disclosed technology. The present disclosure is not limited to the examples provided. Although the above descriptions have explained the various embodiments of the present disclosure, a person having ordinary skill in the art can appreciate that one can modify the disclosed embodiments, or replace certain technical features with equivalent technical features. Such modification or replacement do not make the modified embodiments deviating from the scope of the present disclosure.

A person having ordinary skill in the art can appreciate that when the description mentions “an embodiment” or “an example,” it means that characteristics, structures, or features related to the embodiment or example are included in at least one embodiment or example of the present disclosure. Thus, when the description uses “in an embodiment” or “in an example” or similar terms, it does not necessarily mean the same embodiment. Various characteristics, structures, or features of various embodiments may be combined in a suitable manner. Various characteristics, structures, or features of one embodiment may be incorporated in another embodiment.

A person having ordinary skill in the art can appreciate that the reference numbers for the steps of the methods does not necessarily indicate the sequence of execution of the steps. The sequence for executing the various steps is to be determined by the functions of the steps and the internal logic between the steps. The example sequence shown in the flow charts or discussed in the descriptions should not be construed as limiting the scope of the present disclosure.

A person having ordinary skill in the art can appreciate that when the term “and/or” is used, the term describes a relationship between related items. The term “and/or” means three relationships may exist between the related items. For example, A and/or B can mean A only, A and B, and B only. The symbol “I” means “or” between the related items separated by the symbol.

A person having ordinary skill in the art can appreciate that part or all of the above disclosed methods and processes may be implemented using related electrical hardware, or a combination of electrical hardware and computer software that may control the electrical hardware. Whether the implementation is through hardware or software is to be determined based on specific application and design constraints. A person of ordinary skill in the art may use different methods for different applications. Such implementations fall within the scope of the present disclosure.

A person having ordinary skill in the art can appreciate that descriptions of the functions and operations of the system, device, and unit can refer to the descriptions of the disclosed methods.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method of generating a flight path, comprising:
obtaining an image and a curve, the curve being plotted on the image; and
generating the flight path based on the image and the curve, the flight path being configured for controlling an unmanned aerial vehicle (UAV) to fly along the flight path.

2. The method of claim 1, wherein obtaining the image and the curve comprises:
obtaining a real time image captured by an imaging device carried by the UAV;
displaying the real time image on a display screen;
receiving the curve plotted on the real time image that is displayed on the display screen; and
obtaining the image, the image comprising at least a portion of the real time image on which the curve is plotted.

3. The method of claim 1, wherein:
obtaining the image and the curve comprises obtaining the image and the curve from a gimbal; or
the method of generating the flight path is executed by a first ground station, and obtaining the image and the curve comprises receiving the image and the curve from a second ground station.

4. The method of claim 2, wherein:
obtaining the image and the curve comprises obtaining at least one of an altitude of the imaging device relative to a ground when the imaging device captures the image, an angle of the imaging device relative to the ground, coordinates of each pixel point of the curve in a coordinate system associated with the image, or a focal length of the imaging device; and
generating the flight path based on the image and the curve comprises:
determining a three-dimensional path points set based on at least one of the altitude of the imaging device relative to the ground when the imaging device captures the image, the angle of the imaging device relative to the ground, the coordinates of each pixel point of the curve in the coordinate system associated with the image, or the focal length of the imaging device, wherein the three-dimensional path points set comprises three-dimensional path points in a ground coordinate system corresponding to pixel points, the pixel points being pixel points of the curve plotted on the image; and
generating the flight path based on the three-dimensional path points set.

5. The method of claim 4, wherein generating the flight path based on the three-dimensional path points set comprises:
pre-processing the three-dimensional path points set to generate pre-processed three-dimensional path points set; and
determining the flight path using a flight path generating algorithm based on the pre-processed three-dimensional path points set, the flight path satisfying kinematic constraints of the UAV.

6. The method of claim 5, wherein pre-processing the three-dimensional path points set comprises at least one of:
obtaining a maximum flight distance of the UAV and pre-processing the three-dimensional path points set based on the maximum flight distance;
obtaining a density of at least partially continuous three-dimensional path points from the three-dimensional path points set, and pre-processing the at least partially continuous three-dimensional path points based on the density;
obtaining a degree of jittering of a three-dimensional path point in the three-dimensional path points set, and pre-processing the three-dimensional path point based on the degree of jittering; or
generating a three-dimensional path based on a plurality of at least partially continuous three-dimensional path points included in the three-dimensional path points set, and pre-processing the plurality of at least partially continuous three-dimensional path points based on a curvature of the three-dimensional path.

7. The method of claim 4, wherein determining a three-dimensional path points set based on at least one of the altitude of the imaging device relative to the ground when the imaging device captures the image, the angle of the imaging device relative to the ground, the coordinates of each pixel point of the curve in the coordinate system associated with the image, or the focal length of the imaging device, comprises:
determining a back-projection point on the ground for each pixel point, the back-projection point being a crossing point between the ground and a ray formed from an optical center of a lens of the imaging device to the pixel point;
determining coordinates of the back-projection point in a camera coordinate system based on the coordinates of the pixel point in an image coordinate system associated with the image, and the focal length of the imaging device;
determining coordinates of the back-projection point in the ground coordinate system based on the coordinates of the back-projection point in the camera coordinate system; and
determining the three-dimensional path point corresponding to the pixel point in the ground coordinate system based on the altitude of the imaging device relative to the ground when the imaging device captures the image, and the coordinates of the back-projection point in the ground coordinate system.

8. The method of claim 1, wherein controlling the UAV to fly along the flight path comprises:
when the UAV flies along the flight path, determining whether there is an obstacle in front of the UAV along the flight path;
when there is the obstacle in front of the UAV along the flight path, activating an obstacle avoidance function of the UAV; and
after the UAV avoids the obstacle, controlling the UAV to resume flight along the flight path.

9. The method of claim 1, further comprising:
transmitting the flight path to a server; or
when the method of generating the flight path is implemented by a first ground station, transmitting the flight path to a second ground station.

10. A control device, comprising:
one or more processors, operating individually or in collaboration, and being configured to:
obtain an image and a curve, the curve being plotted on the image; and
generate the flight path based on the image and the curve, the flight path being configured for controlling an unmanned aerial vehicle (UAV) to fly along the flight path.

11. The control device of claim 10, wherein the control device is a ground station or a flight control device.

12. The control device of claim 11, wherein the control device is the flight control device or is included in the flight control device, the control device further comprising:
a receiver communicatively coupled with the one or more processors, the receiver being configured to receive the flight path transmitted from the ground station, wherein the one or more processors are also configured to control the UAV to fly along the flight path; or
wherein the control device is the ground station, or is included in the ground station, and wherein the control device further comprises:
a transmitter communicatively coupled with the one or more processors, the transmitter being configured to transmit the flight path to the flight control device associated with the UAV.

13. The control device of claim 10,
wherein the control device is a ground station, or is included in the ground station,
wherein the one or more processors are further configured to:
obtain real time images captured by the imaging device carried by the UAV,
wherein the control device further comprises:
a display screen configured to display the real time images and to detect the curve plotted on at least one of the real time images, and
wherein the one or more processors are further configured to obtain the curve and the image, the image comprising at least part of the real time images on which the curve is plotted.

14. The control device of claim 10, wherein the one or more processors are configured to obtain the image and the curve, or
wherein the control device is a first ground station, or is included in the first ground station, and the control device further comprises a receiver communicatively coupled with the one or more processors, the receiver being configured to receive the image and the curve transmitted from the second ground station.

15. The control device of claim 13,
wherein obtaining the image and the curve by the one or more processors further comprises:
obtaining at least one of an altitude of the imaging device relative to a ground when the imaging device captures the image, an angle of the imaging device relative to the ground, coordinates of each pixel point of the curve in a coordinate system associated with the image, or a focal length of the imaging device,
wherein generating the flight path based on the image and the curve by the one or more processors further comprises:
determining a three-dimensional path points set based on at least one of the altitude of the imaging device relative to the ground when the imaging device captures the image, the angle of the imaging device relative to the ground, the coordinates of each pixel point of the curve in the coordinate system associated with the image, or the focal length of the imaging device,
wherein the three-dimensional path points set comprises three-dimensional path points in a ground coordinate system corresponding to pixel points, the pixel points being pixel points of the curve plotted on the image; and
generating the flight path based on the three-dimensional path points set.

16. The control device of claim 15, wherein generating the flight path based on the three-dimensional path points set comprises:
pre-processing the three-dimensional path points set to generate pre-processed three-dimensional path points set; and
determining the flight path using a flight path generating algorithm based on the pre-processed three-dimensional path points set, the flight path satisfying kinematic constraints of the UAV.

17. The control device of claim 16, wherein pre-processing the three-dimensional path points set by the one or more processors comprises:
obtaining a maximum flight distance of the UAV and pre-processing the three-dimensional path points set based on the maximum flight distance;
obtaining a density of at least partially continuous three-dimensional path points from the three-dimensional path points set, and pre-processing the at least partially continuous three-dimensional path points based on the density;
obtaining a degree of jittering of a three-dimensional path point in the three-dimensional path points set, and pre-processing the three-dimensional path point based on the degree of jittering; and
generating a three-dimensional path based on a plurality of at least partially continuous three-dimensional path points included the three-dimensional path points set, and pre-processing the plurality of at least partially continuous three-dimensional path points based on a curvature of the three-dimensional path.

18. The control device of claim 15, wherein determining a three-dimensional path points set based on at least one of the altitude of the imaging device relative to the ground when the imaging device captures the image, the angle of the imaging device relative to the ground, the coordinates of each pixel point of the curve in the coordinate system associated with the image, or the focal length of the imaging device, comprises:
determining a back-projection point on the ground for each pixel point, the back-projection point is a crossing point between the ground and a ray formed by an optical center of a lens of the imaging device and the pixel point;
determining coordinates of the back-projection point in a camera coordinate system based on the coordinates of the pixel point in an image coordinate system associated with the specific image, and the focal length of the imaging device;
determining coordinates of the back-projection point in the ground coordinate system based on the coordinates of the back-projection point in the camera coordinate system; and
determining the three-dimensional path point corresponding to the pixel point in the ground coordinate system based on the altitude of the imaging device relative to the ground when the imaging device captures the image, and the coordinates of the back-projection point in the ground coordinate system.

19. The control device of claim 18, further comprising:
a sensor communicatively coupled with the one or more processors, the sensor being configured to detect whether there is an obstacle in front of the UAV on the flight path, and transmit a result of the detecting to the one or more processors,
wherein when detecting that there is the obstacle in front of the UAV on the flight path, the one or more processors are also configured to control the UAV to avoid the obstacle, and
wherein after avoiding the obstacle, the one or more processors are also configured to control the UAV to resume flight along the flight path.

20. An unmanned aerial vehicle (UAV), comprising:
a body;
a propulsion system mounted to the body and configured to provide a propulsion force for flight; and
a flight control device communicatively coupled with the propulsion system, the flight control device configured to control the flight of the UAV,
wherein the flight control device comprises a control device, the control device comprising:
one or more processors, operating individually or in collaboration, the one or more processors being configured to:
obtain an image and a curve, the curve being plotted on the image; and
generate the flight path based on the image and the curve, the flight path being configured for controlling the UAV to fly along the flight path.
